(19) United States
(12) Patent Application Publication
(10) Pub. No.: US 2025/0238844 A1
(43) Pub. Date: Jul. 24, 2025

(54) CONTENT AUCTION MEDIATION BASED ON CONFIGURABLE POSITION GROUPS

(71) Applicant: Yahoo Ad Tech LLC, New York, NY (US)

(72) Inventors: Jeffrey Kuwano, San Jose, CA (US); Kevin C. Day, San Jose, CA (US); Matt Chaim, Ft. Lauderdale, FL (US); Myles O. Ciobhain, Dublin (IE); Ashish K. Dharamshi, Sunnyvale, CA (US)

(21) Appl. No.: 18/418,634

(22) Filed: Jan. 22, 2024

(51) Int. Cl. G06Q 30/0273; G06Q 30/0241

(52) U.S. Cl. CPC G06Q 30/0275; G06Q 30/0249; G06Q 30/0277

(57) ABSTRACT

One or more systems and/or methods that provide configurable ad spaces based on configurable content position groups, rather than single content positions, and bid requests containing configuration information describing the position groups, as well as auctions configured to take advantage of the configurability provided by the use of position groups. In an example, a content service platform may receive position group requests and provide auctions mediated by one or more mediation protocols tailored to positions groups and optionally specified by the bid request.

### BACKGROUND

Many publishers of digital content provide various digital platforms for viewing their content—platforms such as websites, social media applications, mail applications, mobile apps, etc. Such publisher platforms may provide opportunities for publishers to request third parties, such as advertisers, to bid on the use of portions of their platform display (e.g., portions of publisher webpages, user interfaces, screens, etc.) to display third party digital content along with the publisher's content, such as advertisements, media, video, etc. Such publisher platforms also present opportunities for third parties, such as advertisers, to potentially display their content to a wide audience, and such third parties may wish to bid on one or more rights to utilize the publisher's display portions for displaying the third party content.

Content serving platforms may provide real time bidding auctions where publishers may request that third parties bid on opportunities to utilize portions of the publisher's display, and third parties may bid on such requests, and where the content of the winning bid may be served to the publisher's display portion.

Often, however, the bidding opportunities may be limited or overly constrained by the display portion configuration and the auction itself, resulting in displays that are not optimized in their presentation of content and in less flexibility for publishers and content providers to tailor their bidding opportunities and bids.

### SUMMARY

In accordance with the present disclosure, one or more systems and/or methods are provided. In an example a content serving platform stores a plurality of content bids, where each content bid comprises bid information including at least one content item (e.g., advertisement), and associated position and budget information. The content serving platform may receive a position group request from a publisher. The position group request may comprise a location identifier for display space that is the subject of the bid request. The request may also include position group configuration information that includes at least one position group definition specifying at least two positions (ad types). In response, the content serving platform may conduct an auction of the plurality of content bids using the position group configuration information to mediate the auction according to a mediation protocol configured on the platform. The content serving platform may then determine a winning bid or bid combination and send the at least one content item specified in the winning bid or bid combination to the location identified by the location identifier.

In an example, the mediation protocol is either a ranked score protocol or an eCPM protocol, where CPM is cost-per-thousand.

In an example, the position group configuration information includes a mediation protocol identifier, and the content serving platform conducts the auction according to a mediation protocol indicated by the mediation protocol identifier.

In another example, a content serving platform stores a plurality of content bids, where each content bid comprises bid information including at least one content item (e.g., advertisement), and associated position information. The content serving platform may receive a position group request from a publisher. The position group request may comprise configuration information that includes a location identifier for display space that is the subject of the bid request. The configuration information may also include first and second mediation rules. Each mediation rule may include a plurality of position group definitions and a mediation protocol identifier. In response to the request, the content serving platform may conduct an auction of the plurality of content bids. The auction may comprise first and second auction rounds. The content serving platform may conduct the first auction round by mediating a first plurality of position groups defined by the first plurality of position group definitions against each other using a first mediation protocol indicated by the first mediation protocol identifier. The second round may likewise be conducted using second round information and second mediation protocol. The content serving platform may then determine a winning bid or bid combination for each round and send the at least one content item specified in the winning bid or bid combination to the location identified by the location identifier.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing real time content auctions based on content product groups.

FIG. 5A is a component block diagram illustrating an example content serving platform and environment for providing content auctions based on configurable content position groups.

FIG. 5B is a component block diagram illustrating examples of publisher displays containing ad spaces.

FIG. 6A is a component block diagram illustrating an ad slot and a scenario in which the ad slot is configured to request bids involving only single ad positions.

FIG. 6B is a component block diagram illustrating an ad slot and a scenario in which the ad slot is configured to request bids involving position groups.

FIG. 7 is an illustration of a scenario featuring an example non-transitory machine readable medium in accordance with one or more embodiments set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

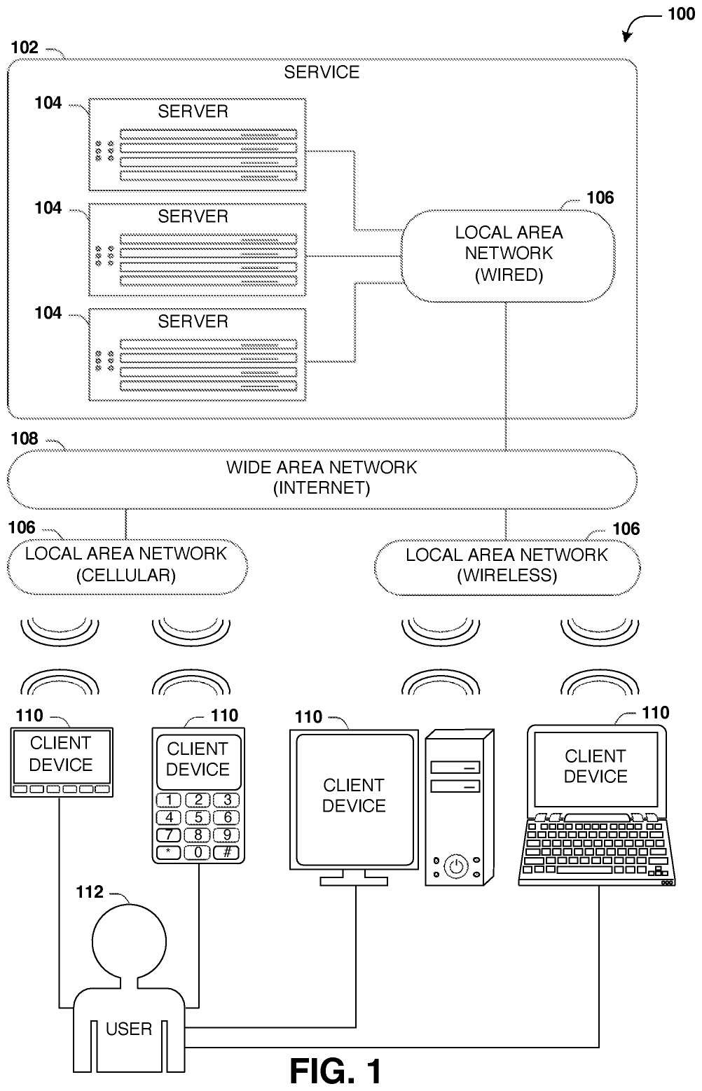

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP)). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

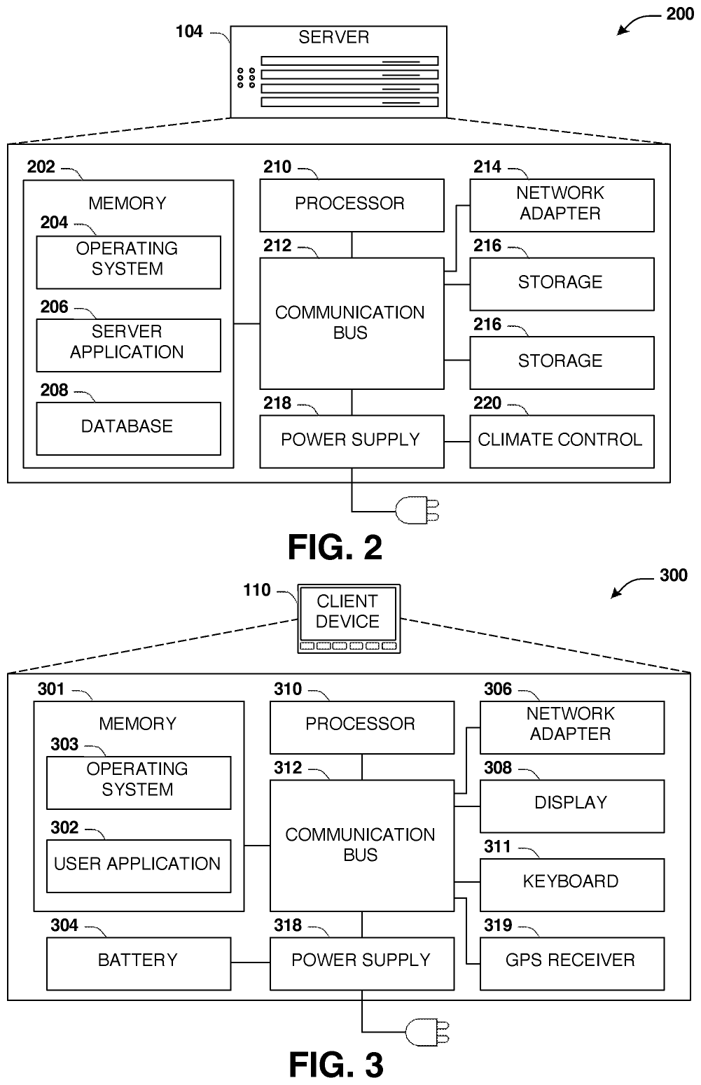

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

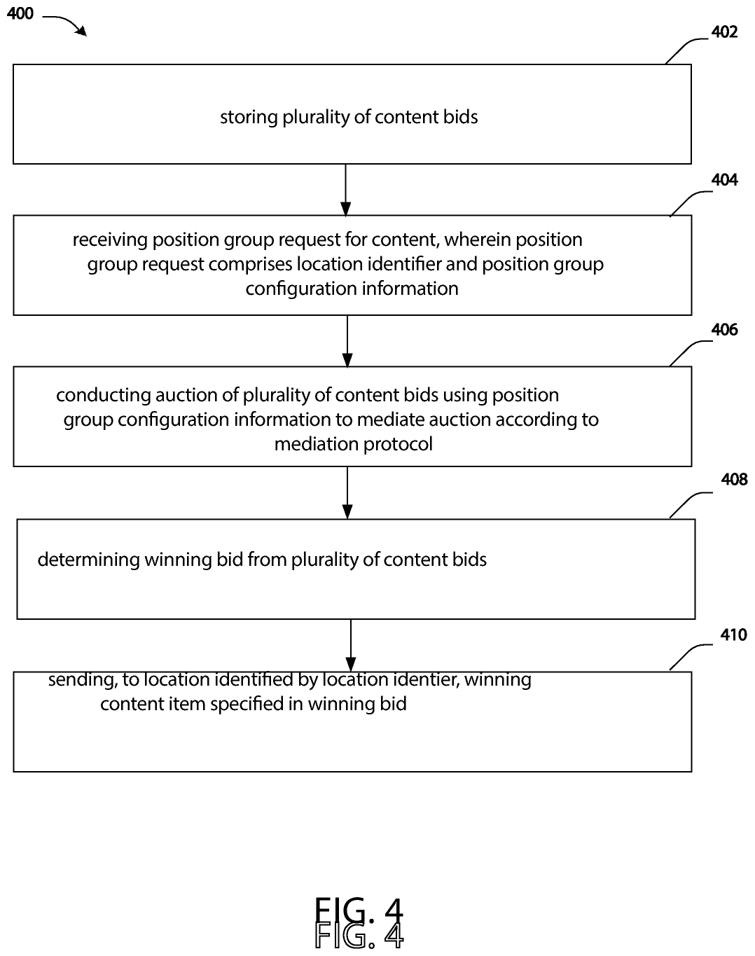

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

In the present disclosure, systems and methods are described for conducting digital content auctions based on position groups of digital content items, rather than individual positions. The disclosed systems and methods allow for greater flexibility in the operations of digital content auctions and displays. Therefore, application of the disclosed systems and methods to various digital content models as discussed in further detail below serves to improve flexibility and efficiencies of the digital content auction and display process.

In general, a content serving platform may serve users with digital content items (e.g., news articles, informational articles, videos, advertisements, images, links, etc.), which may be displayed through a publisher's digital medium (e.g., website, web application, text messages, notifications, social network feeds, mobile app screens, and/or other user interfaces displayed on computing devices). Of particular interest to the embodiments herein are content items comprising digital advertisements. Note, the terms “digital content”, “digital content items”, “content items”, and “content” are used interchangeably herein, and may be understood to refer to advertisements, unless context dictates otherwise.

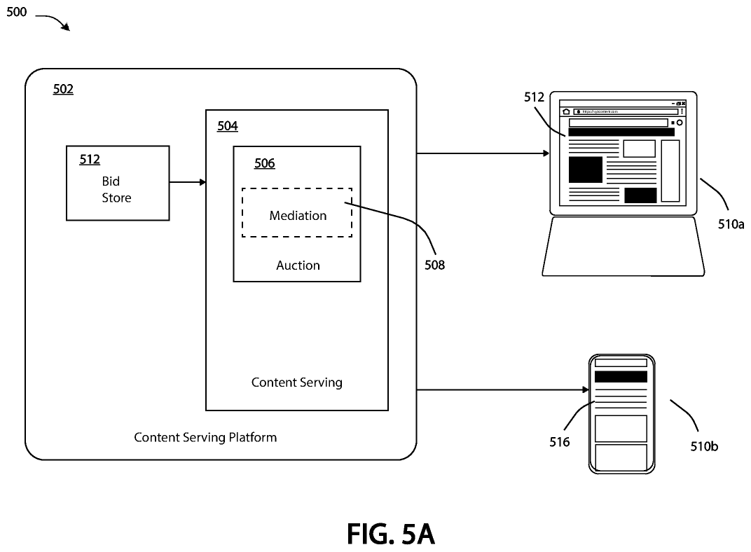

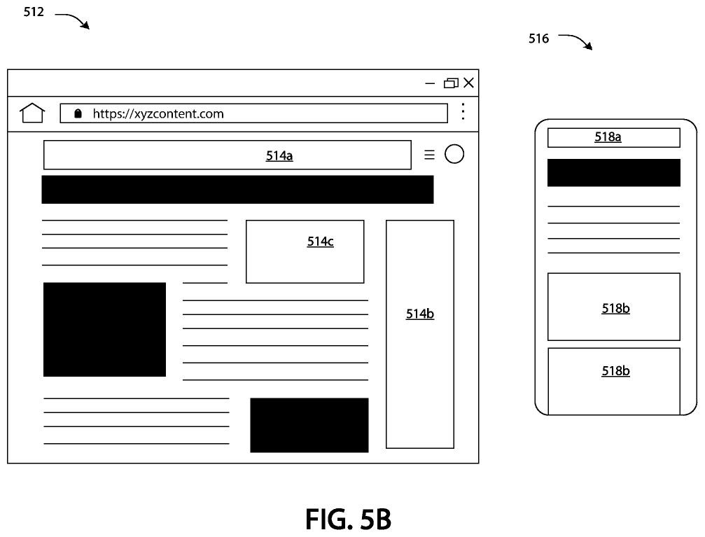

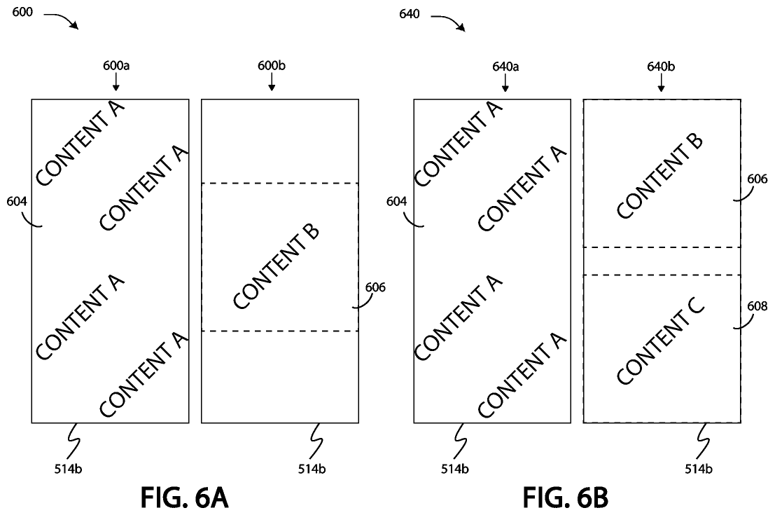

An embodiment of conducting content auctions based on position groups is illustrated by an example method 400 of FIG. 4, and is further described in conjunction with the content serving platform 502 of FIG. 5A, client devices of FIG. 5B, and aspects illustrated in FIGS. 6A and 6B.

With reference to FIG. 5A, illustrated is a system 500 that includes a content serving platform 502 in accordance with an embodiment of the present disclosure. Content serving platform 502 may comprise content serving functionality 504, which may comprise digital content auction 506. (Note, the terms “digital content auction”, “auction system”, and “auction” are used interchangeably herein.) Auction 506 may comprise generally any content auction component(s), module(s), system, etc., sufficient to provide the functionality described herein, which includes the real time mediation of bids supplied by content producers (e.g., advertisers) and/or generated by the system using bid information supplied by content producers (as indicated by bids store 512 in. FIG. 5A). For example, in some embodiments auction 506 may utilize a mediation engine/module 508 to determine a highest-ranking bid or bids among a plurality of digital content bids, according to one or more mediation models, rules, or methods, as further described herein, and return the content items specified in the winning bid, and/or a reference to the content items, to the requester. Note that, as used herein, any references to a “winning bid” may include both a winning bid (one bid) and a winning combination of bids (multiple bids), and any reference to a “winning content item” may include both a content item from a winning bid (one content item) and content items from a winning combination of bids (multiple content items), as the case may be.

When a user of a client computing device, such as client devices 510a and 510b, accesses a publisher's content (e.g., website, application user interface, etc.) for which the content serving platform 502 is enabled, the content serving platform 502 may receive one or more calls or requests for digital content (e.g. advertisements) in relation to the publisher's displayed content, as further described below.

In some examples, as in the embodiment shown in FIG. 5A, client device 510a (a desktop machine) may be running a web browser application that is used to display a publisher's site (e.g., webpage 512). Generally, a web browser may display a publisher's webpages by requesting the publisher's web server (not shown) to serve it publisher content and rendering the content in a browser window on the client device. In responding to the web browser's request, in some embodiments the publisher's web server may be configured to retrieve content items (e.g., advertisements) served by content serving platform 502 (or references to such items (e.g., URLs)), by making one or more calls or requests for digital content items, to incorporate into the webpage content that it serves its client device's web browser, which displays the digital content items as part of the webpage, as represented by slots 514 displayed on webpage 512. In other embodiments, the publisher's web server may provide functionality in the content it serves to its client device (e.g., ad tags) that allows the web browser to make one or more calls or requests for digital content items (e.g., advertisements) served by content serving platform 502, to display as part of the webpage.

In some examples, and with continuing reference to FIG. 5A, client device 510b (a mobile device) may be running an app that displays a publisher's content (e.g., social media feed, email, news service, etc.) on one or more screens (user interfaces) 516. Generally, a screen may be displayed based on locally stored templates or other patterns that provide screen portions that are enabled to provide updated content from one or more web services and/or content serving platforms, such as via requests or calls to such web services.

With reference now to FIG. 5B, illustrated there are larger views of exemplary displays of client devices 510a and 510b, provided to further describe digital content items (e.g., ads), as displayed on client devices. In general, as may be seen in FIG. 5B, in some embodiments disclosed herein, displayed publisher's content may comprise portions 514,518 of the rendered interface (e.g., web page, app screen), generally referenced hereinafter as “slots” and/or “ad slots” (in the case where such requested content is digital ads) that may be set aside or allocated for displaying content requested from content serving platform 502.

In general, ad slots may be implemented in the disclosed embodiments in any manner sufficient to provide the functionality described herein. For example, in some embodiments, slots may be implemented as frames, containers, or the like capable of executing code on the client device that, for example, initiates and handles calls to content serving platform 502 requesting ad content. In some embodiments, ad slots may be implemented in a relatively fixed or static manner on the publisher's web server side or app services side by one or more page-building operations, including retrieving third-party content (e.g., ad content from content serving platform 502) by making one or more calls requesting such content, and loading it to the client directly. Unless context dictates otherwise herein, references herein to “requests for digital content” or “requests for content” may be understood to comprise any of the aforementioned calls, and any analogous calls or requests on content serving platform 502 made in relation to any particular implementation of the systems disclosed herein, however architected. Note that when referencing screen space occupied by an ad slot, the terms “ad space” or “location” are sometimes used; as used in this disclosure, the terms “slot”, “ad slot”, “ad space”, and “location” may be used interchangeably, unless context dictates otherwise.

In general, slots may be located in any suitable location within the published content such as, for example, in generally any location on the webpage or app screen. For example, with reference to FIG. 5B, in some embodiments, slots may be located at the top of a web page or screen (e.g., within a banner area) (slot 514a, 518a), at the side of the web page (e.g., within a column 514b), in the midst of publisher content (slot 514c, 518b), in a pop-up window, overlaying content of the web page, etc.

In practice, slots that are potentially available to a publisher when building and implementing a webpage, app, or the like, may be any that are specified in accordance with a standard or a given type or brand of content serving platform implementation (e.g., a platform's API), such that content requests from publishers and bids from advertisers may use common references and be capable of being mediated by the content serving platform.

Positions. In some embodiments, ad space may be denoted by a “position” label. In general, any term may be used as a position label, and a position label may serve as a tag, label, or other identifier of a particular content item and/or type of content item if it is used and applied by users of a content service platform (e.g., publishers/sellers of ad space, advertisers/buyers of ad space) in a common manner, such as according to an API specification and/or industry standard. In many implementations, position labels may convey information about the dimensions of the content item bearing the label, as well as precise or relative location information of the slot in which the labeled content will be displayed. For example, in some embodiments, position labels may be utilized by publishers to configure the type of content items that may be displayed in a particular ad slot, and by auction bidders (e.g. advertisers) in their bids to denote which ad slots their content items are being bid against.

In some embodiments, positions labels that may be utilized may comprise terms that denote relative tiers or sets of preference in a publisher's ad space. For example, positions with highest preference (e.g., positions that denote locations “above the fold” on a publisher's webpage) or “first tier” labels may be denoted with no number or the number “1” as part of the label. In some embodiments, positions with lesser preferred positions may be similarly denoted in ranked order (e.g., with a number “2”, “3”, etc.), typically denoting ad space that is further down in a webpage or screen. Additionally, the label names may denote locations and/or relative dimensions. So, for example, the term “LREC” may denote a content item having dimensions (width×length) in pixels of (300×250); the term “LDRB” may denote a content item having dimensions (728×90); “MON” may denote content items with dimensions of (300×600); “MAST” may denote content items with dimensions (970×250); “SKY” may denote content items with dimensions (120×600), etc. In some implementations, position names may denote fixed locations; in others, relative or varied locations. It should be appreciated that the naming convention is not material, but rather the common understanding and usage by a particular environment's users (e.g., publishers, advertisers, content serving platform providers, etc.). For the purposes of illustration of the embodiments herein, the following positions may be referenced: LREC, LREC2, LREC3, LREC4 (denoting 300×250 content items of decreasing location desirability); LDRB, LDRB2, LDRB3, LDRB4 (denoting 728×90 content items of decreasing location desirability); MON, MON2, MON3, MON4 (denoting 300×600 content items of decreasing location desirability); MAST (denoting 970×250 content items); and SKY, SKY2, SKY3, SKY4 (denoting 120×600 content items of decreasing location desirability).

Position Groups. The systems and methods disclosed herein provide a novel content auction that mediates bids based on groups of N positions (where N may be 1 or more), rather than individual positions, and thereby provides greater flexibility to publishers and advertisers in structuring their offerings (ad space/impressions and bids for the same, respectively), and provides more efficient use of overall publisher content space.

Utilizing the systems and methods disclosed herein, a publisher may configure his display space (e.g., webpage, mobile app, etc.) such that one or more slots (e.g., slot 514b in FIG. 5B) may display position group content—e.g., a plurality of positions/ads—and may be supplied with position group content using position group requests, as further described below.

For example, reference is made to FIGS. 6A & 6B, which illustrate two scenarios, 600 and 640, involving slot 514b of FIG. 5B, a (300×600) ad space. In scenario 600, two outcomes, 600a & 600b, of a content request and real time bidding auction involving only single position mediation is represented. In this scenario, slot 514b is configured to only receive one position (one ad) and the corresponding auction responsive to any requests for content linked to this slot involves evaluation and mediation of only a single position among the bids. In outcome 600a, the single MON position 604 (i.e., a 300×600 ad) was returned from the relevant auction and fills the entire slot 514b. In outcome 600b, the single LREC position 606 (i.e., a 300×250 ad) was returned from the relevant auction and fills only a portion (less than ½) of slot 514b.

In contrast, scenario 640 shows two outcomes, 640a & 640b, of a content request and real time bidding auction involving position group mediation. In this scenario, slot 514b is configured to receive at least one position group (multiple ads) and the corresponding auction responsive to any requests for content linked to this slot involves evaluation and mediation of at least one position group from among the bids. In outcome 640a, the single MON position 604 (i.e., a 300×600 ad) was returned from the relevant auction and fills the entire slot 514b. In outcome 640b, two single LREC positions, 606 and 608 (i.e., two 300×250 ads) were returned from the relevant auction and fill almost the entirety of slot 514b.

As demonstrated in the scenarios illustrated in FIGS. 6A & 6B, use of the systems and methods disclosed herein results in greater utilization of ad slot space.

Requests. As previously described, systems and methods of the present embodiments provide publishers the ability to request N position groups of content items for individual slots in their published content. Generally, any call or request sufficient to provide the functionality described herein may be utilized. For example, in one or more embodiments, a publisher's displayed content may be configured to initiate one or more position group requests and to display position group content items received in response to such requests. As used herein, unless context dictates otherwise, the term “position group request” may be understood to mean requests for content from content serving platform 502 by server or client-side calls that carry configuration information comprising at least slot identifying information and position group configuration information. In some embodiments, slot identifying information may comprise a location identifier uniquely identifying the slot to which the request is associated (e.g., the slot to which the content items responsive to the request should be sent). In some embodiments, the position group configuration information may comprise specifying information of at least one position group containing at least two positions.

In some embodiments, position group requests may include configuration information formatted in JSON, and have position group configuration information that includes a position property specifying (via a JSON array or similar structure) at least one position group containing at least two positions. For example, position group configuration information of some embodiments may take a form comprising: { . . . , “position_groups”: [[“POS1”, “POS2”], . . . ], . . . }. In some more common embodiments, position group configuration information may include a positions property specifying a single position and at least one position group containing at least two positions. For example, position group configuration information in some embodiments may take the form comprising: { . . . , “position_groups”: [[“POS1”], [“POS2”, “POS3”], . . . ], . . . }.

As described in more detail below, a content serving platform according to the present embodiments may be configured to run real time bid auctions in response to position group requests that mediate between position groups having two or more positions (N>=2), or between a position group and a single position (e.g., a position group where N=1), such as those disclosed by the position group configuration information set forth in this example, to determine a winning bid according to a mediation protocol. It should be appreciated that the embodiments disclosed herein are not limited to requests in JSON format or the particular configuration information set forth in this example, and that generally any similar formatting and configuration sufficient to provide the functionality disclosed herein may be implemented.

Auctions. With reference again to FIG. 5A, in general, demand side users (e.g., advertisers, content producers, etc.) may upload bids and/or bid information to content serving platform 502, together with content items (e.g., ads) and/or references to content items, with which the bids or bid information may be associated. Such information may be stored in any suitable manner, as in bid store 512. In some embodiments, responsive to receiving a request for content, auction 506 may conduct an auction associated with the request for content, a real time bid auction. A winning bid of the auction may be determined based on one or more mediation protocols configured for the auction, and the content (or reference to the content) associated with the winning bid may be served and/or sent to the requesting slot on the requesting device.

In some embodiments, auction 506 may be configured to mediate an auction among a plurality of bids for an incoming position group request, determining the bid resulting in the highest rank for the at least one position group specified in the request's position group configuration information, according to at least one mediation protocol. In some embodiments, the at least one mediation protocol is a summation protocol that determines the highest potential effective CPM (eCPM) for each of the least one positions groups specified in the request's position group configuration information, from among the bids, and returns the content items from the winning bid.

In some embodiments, auction 506 may be configured to evaluate a plurality of position groups specified in a single position group request and mediate them against each other according to one or more mediation protocols to determine an overall winning (highest ranking) bid for the request. In some embodiments, the one or more mediation protocols comprises a summation protocol that determines the highest potential effective CPM (eCPM) for each of the position groups specified in the request from among the bids, and selects the position group with the highest eCPM value as the winner and returns the content associated with the winning bid.

To illustrate: in one example, content serving platform 502 may receive a request for content (e.g. ad content) for a publisher's “first tier” 300×600 ad slot (e.g., a “MON” slot), in which the configuration information uniquely identifies the associated ad slot and the position group configuration information specifies the following two position groups: (i) one 300×600 ad (i.e., the position group is a position group of N=1); and (ii) two 300×250 ads. In response, auction 506 mediates the auction by evaluating the available bids to determine the position group yielding the highest eCPM (highest eCPM value of the single 300×600 position group vs. the highest combined/summed eCPM of the position group comprising two 300×250s). The requesting ad space is then served the content items associated with the bid or bids from which the winning position group was determined in the auction.

Referring now to FIG. 4, in some embodiments, at step 402 a plurality of content bids may be stored at content serving platform 502. A content bid may comprise at least the following bid information: at least one content item (e.g., an advertisement or content with which to render an advertisement), position information associated with the at least one content item, and budget information associated with the at least one content item. Position information may generally by understood to refer to the position type specified for the content (e.g., “MON”, “LREC”, “SKY”, “LREC2”, “MON2”, etc.). Budget information may generally include a ceiling price (CMP) offered for the opportunity being bid upon. Note that a given content item in a bid may be associated with more than one tier of a position type (e.g., LREC, LREC2, LREC3, etc.), and more than one ceiling price, with each ceiling price corresponding to a different position tier.

In some embodiments, at step 404 content serving platform 502 receives a position group request for content. The position group request may comprise a location identifier and position group configuration information. In some embodiments, the position group configuration information may comprise at least one position group definition comprising at least two specified positions (i.e., N>=2). In some embodiments, the position group configuration information may comprise a mediation protocol identifier.

At step 406, in some embodiments, in response to the position group request, the content serving platform 502 may conduct an auction of the plurality of content bids using the position group configuration information to mediate the auction according to a mediation protocol. In some embodiments, the mediation protocol may be a ranked score protocol; in some embodiments, the mediation protocol may be an eCMP protocol, as described further in relation to step 408, below. In some embodiments, the auction is conducted using the mediation protocol identified by the mediation protocol identifier included in the position group configuration information.

At step 408, in some embodiments, the content serving platform 502 may determine a winning bid from the plurality of content bids. In some embodiments, the mediation protocol may comprise determining for each configured position group the highest ranked score, using bid information from the plurality of bids, and selecting the position group yielding the highest ranked score as the winning bid. Ranked scores may be determined in generally any suitable manner, and in some embodiments may be based on factors such as advertiser and/or publisher goals (e.g., target audience, click rate, etc.). In some embodiments, the mediation protocol may comprise determining for each configured position group the highest eCPM sum total, using bid information from the plurality of bids, and selecting the position group yielding the highest sum total as the winning bid.

At step 410, in some embodiments, the content serving platform 502 may send or cause to be sent the at least one content item specified in the winning bid, to the location identified by the location identifier.

Referring to FIG. 5, in some embodiments, content serving platform 502 may be configured to receive position group requests that contain configuration information comprising a parameter configurable so as to identify a mediation protocol to be utilized by the content serving platform and may be configured to run a position group auction responsive to the request that utilizes the mediation protocol identified in the request. For example, in some embodiments, position group requests may be configured to include in the position group configuration information a property having configurable identifier values associated in the content serving platform with a particular mediation protocol to run. Drawing from the JSON example above, in some embodiments, a position group request may comprise position group configuration information taking a form similar to the following: { . . . , “position_groups”: [[“POS1”], [“POS2”, “POS3”], . . . ], “mediation_type”: “ecpm”, . . . }. It should be understood that position group requests according to the embodiments herein may identify other mediation protocols (e.g., ranked score protocol, manual protocol, etc.) and the content server may be configured to recognize mediation protocol identifiers in requests and run the appropriate meditation protocol in an auction responsive to the request.

Referring still to FIG. 5, in some embodiments, content serving platform 502 may be configured to receive position group requests that contain configuration information comprising a plurality of mediation rules. As used herein, unless context dictates otherwise, a “mediation rule” may be understood to refer to configuration information that specifies a plurality of position groups to be mediated against each other, and a mediation protocol to be used in the mediation. In addition, content serving platform 502 may be configured to run an auction responsive to a position group request containing a plurality of mediation rules in which the auction is implemented in multiple rounds, wherein each round mediates the position groups specified in a single mediation rule in the request, using the mediation protocol specified in the rule, and configured to send the content item(s) from the winning bid in each round to the location specified in the request. As may be appreciated, a publisher wishing to display differing sets of content items in a single ad slot may utilize a single position group request specifying a plurality of mediation rules, according to embodiments of the present disclosure.

So, for example, in one or more embodiments, and drawing again on the JSON example set forth above, in some embodiments, a position group request containing mediation rules may comprise position group configuration information taking a form similar to the following: { . . . , “mediations_rounds”: {“position_groups”: [[“POS1”], [“POS2”, “POS3”], . . . ], “mediation_type”: “ecpm”, . . . }, {“position_groups”: [[“POS1”, “POS4”], [“POS2”, “POS3”], . . . ], “mediation_type”: “ranked_score”, . . . }, . . . , . . . }. It should be understood that position group requests according to the embodiments herein may identify other mediation rules specifying other position groups or mediation protocols (e.g., manual protocol, etc.) and the content server may be configured to recognize mediation protocol identifiers in requests and run the appropriate meditation protocol in an auction responsive to the request.

It may be appreciated that the disclosed subject matter may assist content publishers in creating highly configurable bid requests for content to display, and therefore create more configurable display options for end users to view. In this manner, the disclosed subject matter provides more efficient use of screen space, as publishers are able to design and configure their ad space using any number of possible positions/ad types and position sets that may fit into the ad space, rather than being limited by the request and auction to only single positions.

It may also be appreciated that the disclosed subject matter may assist content publishers and advertisers be more efficient in their bid requests and bidding. By allowing for tailored auctions involving multiple rounds, as specified by a single bid request, publishers are able to reduce the number of bid requests they need to make to fill their content requirements.

It may also be appreciated that the disclosed subject matter may assist content providers (e.g., advertisers) by increasing impression opportunities to bid on, corresponding to bid requests (and connected ad slots) configured based on groupings of ad positions, rather than individual positions per slot.

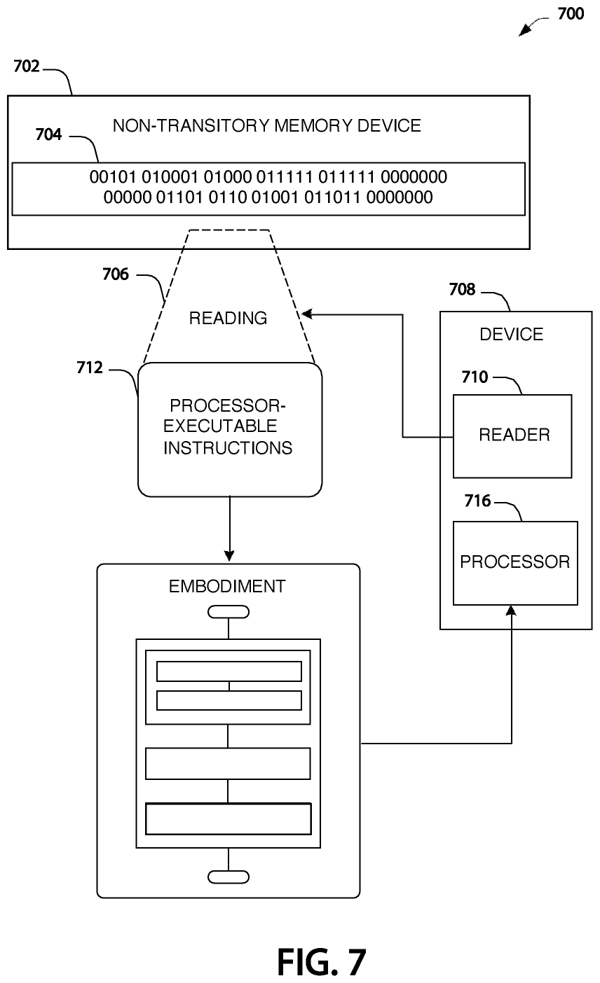

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein. The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 702 stores computer-readable data 704 that, when subjected to reading 806 by a reader 710 of a device 708 (e.g., a read head of a hard disk drive, or a read operation invoked on a solid-state storage device), express the processor-executable instructions 712. In some embodiments, the processor-executable instructions 712, when executed cause performance of operations, such as at least some of the example method 400 of FIG. 4, for example. In some embodiments, the processor-executable instructions 712 are configured to cause implementation of a system, such as at least some of the example system 500 of FIG. 5, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method, comprising:
storing, at a content serving platform, a plurality of content bids, wherein each content bid comprises bid information including a content item, and position information and budget information associated with the content item;
receiving, at the content serving platform, a position group request, wherein the position group request comprises a location identifier and position group configuration information specifying at least two positions;
conducting, by the content serving platform, an auction of the plurality of content bids using the position group configuration information specifying the at least two positions to mediate the auction according to a mediation protocol, wherein the auction evaluates a first combination of bids, from the plurality of content bids, corresponding to a combination of content items in response to the position group request comprising the position group configuration information specifying the at least two positions;
determining, by the content serving platform, a winning bid combination from the auction, wherein the winning bid combination comprises the first combination of bids; and
sending, to a location identified by the location identifier, one or more winning content items specified in the winning bid combination.

2. The method of claim 1, wherein the one or more winning content items comprise the combination of content items.

3. The method of claim 1, wherein the mediation protocol is a ranked score protocol.

4. The method of claim 1, wherein the mediation protocol is an eCPM protocol.

5. The method of claim 1, wherein the position group configuration information comprises a mediation protocol identifier and wherein the content serving platform conducts the auction according to the mediation protocol based on the mediation protocol identifier.

6. The method of claim 5, wherein the mediation protocol identifier indicates either a ranked score protocol or an eCPM protocol.

7. The method of claim 1, wherein the budget information comprises ceiling price information.

8. The method of claim 1, wherein the position group configuration information comprises:
a first position group definition comprising a first specified position and a second specified position; and
a second position group definition comprising a third specified position and a fourth specified position.

9. A method, comprising:
storing, at a content serving platform, a plurality of content bids, wherein each content bid comprises bid information including a content item, and position information associated with the content item;
receiving, at the content serving platform, a position group request, wherein the position group request comprises configuration information comprising a location identifier and a first mediation rule and a second mediation rule, wherein the first mediation rule comprises a first plurality of position group definitions and a first mediation protocol identifier, and wherein the second mediation rule comprises a second plurality of position group definitions and a second mediation protocol identifier;
conducting, by the content serving platform, an auction of the plurality of content bids comprising a first auction round and a second auction round, wherein the auction evaluates a first combination of bids corresponding to a combination of content items in response to the position group request comprising the first plurality of position group definitions and the second plurality of position group definitions, wherein the content serving platform conducts the first auction round by mediating a first plurality of position groups defined by the first plurality of position group definitions using a first mediation protocol indicated by the first mediation protocol identifier and wherein the content serving platform conducts the second auction round by mediating a second plurality of position groups defined by the second plurality of position group definitions using a second mediation protocol indicated by the second mediation protocol identifier;
determining, by the content serving platform, a first winning bid from the first auction round, wherein the first winning bid is from the plurality of content bids;
determining, by the content serving platform, a second winning bid from the second auction round, wherein the second winning bid is from the plurality of content bids;
sending, to a location identified by the location identifier, a first winning content item specified in the first winning bid; and
sending, to the location identified by the location identifier, a second winning content item specified in the second winning bid.

10. The method of claim 9, wherein at least one of the first winning content item or the second winning content item comprises a digital advertisement.

11. The method of claim 9, wherein at least one of the first mediation protocol or the second mediation protocol is a ranked score protocol.

12. The method of claim 9, wherein at least one of the first mediation protocol or the second mediation protocol is an eCPM protocol.

13. A non-transitory computer-readable storage medium tangibly encoded with computer-executable instructions, that when executed by a processor associated with a computing device, perform a method, the method comprising:
storing, at a content serving platform, a plurality of content bids, wherein each content bid comprises bid information including a content item, and position information and budget information associated with the content item;
receiving, at the content serving platform, a position group request, wherein the position group request comprises a location identifier and position group configuration information specifying at least two positions;
conducting, by the content serving platform, an auction of the plurality of content bids using the position group configuration information specifying the at least two positions to mediate the auction according to a mediation protocol, wherein the auction evaluates a first combination of bids corresponding to a combination of content items in response to the position group request comprising the position group configuration information specifying the at least two positions;
determining, by the content serving platform, a winning bid from the auction, wherein the winning bid is from the plurality of content bids; and
sending, to a location identified by the location identifier, a winning content item specified in the winning bid.

14. The storage medium of claim 13, wherein the winning content item comprises a digital advertisement.

15. The storage medium of claim 13, wherein the mediation protocol is a ranked score protocol.

16. The storage medium of claim 13, wherein the mediation protocol is an eCPM protocol.

17. The storage medium of claim 13, wherein the position group configuration information comprises a mediation protocol identifier and wherein the content serving platform conducts the auction according to the mediation protocol based on the mediation protocol identifier.

18. The storage medium of claim 17, wherein the mediation protocol identifier indicates either a ranked score protocol or an eCPM protocol.

19. The storage medium of claim 13, wherein the budget information comprises ceiling price information.

20. The storage medium of claim 13, wherein the position group configuration information comprises:
a first position group definition comprising a first specified positions and a second specified position; and
a second position group definition comprising a third specified position and a fourth specified position.
